(19) United States
(12) Patent Application Publication
(10) Pub. No.: US 2012/0293550 A1
(43) Pub. Date: Nov. 22, 2012

(54) LOCALIZATION DEVICE AND LOCALIZATION METHOD WITH THE ASSISTANCE OF AUGMENTED REALITY

(75) Inventors: Chi-Chung Lo, Zhuqi Township (TW); Yu-Chee Tseng, Hsinchu City (TW); Chung-Wei Lin, Changhua City (TW); Lun-Chia Kuo, Taichung City (TW); Tsung-Ching Lin, New Taipei City (TW)

(73) Assignees: NATIONAL CHIAO TUNG UNIVERSITY, Hsinchu City (TW); INDUSTRIAL TECHNOLOGY RESEARCH INSTITUTE, HSINCHU (TW)

(21) Appl. No.: 13/285,113

(22) Filed: Oct. 31, 2011

(30) Foreign Application Priority Data
May 17, 2011 (TW) 100117285

(51) Int. Cl. G09G 5/00

(52) U.S. Cl. 345/633

(57) ABSTRACT

A localization device assisted with augmented reality and a localization method thereof are provided. The localization device includes a subject object coordinate generating unit, a relative angle determining element and a processing unit. The subject object coordinate generating unit selects at least three subject objects outside the localization device and obtains at least three subject object coordinate values of the at least three subject objects. The relative angle determining element determines at least two viewing angle differences between any two of the at least three subject objects. The processing unit generates a location coordinate value of the localization device according to the at least two viewing angle differences and the at least three subject object coordinate values.

### CROSS-REFERENCE TO RELATED APPLICATION

This application claims the benefit of Taiwan application Serial No. 100117285 filed May 17, 2011, the disclosure of which is incorporated by reference herein in its entirety.

### BACKGROUND

1. Technical Field

The disclosed embodiments relate in general to a localization device and a localization method and to a localization device assisted with augmented reality and a localization method thereof.

2. Description of the Related Art

In recent years, the location based service has gradually attracted people' attention, and the augmented reality technology is one of the most popular mobile services. The augmented reality technology, which calculates the physical location and the angle of the captured image and puts the corresponding information or picture on the captured image, aims to combining the virtual world and the real world and providing interaction between the two worlds. For example, when the image of a nearby restaurant is captured, the augmented reality technology can put the basic information and recommended menu on the image of the restaurant so as to provide the users with more convenient service. However, the correctness in determining the user's current location is a crucial factor that may affects the performance.

For most existing mobile devices, the user's location is normally obtained through the use of global positioning system (GPS), which is also adapted by most mobile devices assisted with augmented reality. However, the positioning error of the GPS ranges 3˜5 meters, and such error largely may affect the performance of the augmented reality.

One of the currently used methods for correcting the position error is through image processing. For example, the image of signboard can be obtained and used in image recognition to confirm whether the signboard matches the located shop or not. If yes, the information of augmented reality is displayed on the located shop. However, such method may require the collection of signboard images from everywhere, and the mobile devices need to spend tremendous computation time and power consumption on the processing of image recognition.

Therefore, how to provide a location method capable of promptly and effectively locating the user's current location for increasing the correctness and performance of augmented reality has become an imminent task for the industries.

### SUMMARY

The disclosure is directed to a localization device assisted with augmented reality and a localization method thereof for promptly and effectively determining the location of the localization device.

According to one exemplary embodiment, an embodiment of a localization device assisted with augmented reality is provided. The localization device embodiment includes a subject object coordinate generating unit, a relative angle determining element and a processing unit. The subject object coordinate generating unit selects at least three subject objects outside the localization device and obtains at least three subject object coordinate values of the at least three subject objects. The relative angle determining element determines at least two viewing angle differences between any two of the at least three subject objects. The processing unit generates a location coordinate value of the localization device according to the at least two viewing angle differences and the at least three subject object coordinate values.

According to another exemplary embodiment, an embodiment of a localization method assisted with augmented reality used in a localization device is provided. The localization method includes the following steps. At least three subject objects outside the localization device are selected and at least three subject object coordinate values of the at least three subject objects are obtained. At least two viewing angle differences between any two of the at least three subject objects are determined. A location coordinate value of the localization device is generated according to the at least two viewing angle differences and the at least three subject object coordinate values.

According to an alternative exemplary embodiment, an embodiment of a computer program product with a computer program is provided. After the computer program is loaded and executed in a localization device, the localization device completes a localization method assisted with augmented reality. The localization method includes the following steps. At least three subject objects outside the localization device are selected and at least three subject object coordinate values of the at least three subject objects are obtained. At least two viewing angle differences between any two of the at least three subject objects are determined. A location coordinate value of the localization device is generated according to the at least two viewing angle differences and the at least three subject object coordinate values.

### BRIEF DESCRIPTION OF THE DRAWINGS

FIG. 1 shows a block diagram of a localization device assisted with augmented reality of an embodiment of the present disclosure;

FIG. 2 shows a schematic diagram of an example of the relationship between the localization device of FIG. 1 and several subject objects;

FIG. 3 shows an example of an user interface displayed on a screen display;

FIG. 4 shows a flowchart of a localization method according to an embodiment;

FIG. 5 shows an example of a frame display on a screen display;

FIG. 6 shows a schematic diagram of an example of the relationship between the localization device of FIG. 1 and a larger subject object;

FIG. 7 shows a schematic diagram of another example of a user interface;

FIG. 8 shows a schematic diagram of another example of a user interface;

FIG. 9 shows an example of geometric relationship between the localization device of FIG. 2 and several subject objects;

FIG. 10 shows a schematic diagram of a first circle corresponding to the geometric relationship of FIG. 9 with α<90°;

FIG. 11 shows a schematic diagram of a first circle corresponding to the geometric relationship of FIG. 9 with α>90°; and

FIG. 12 shows a schematic diagram of all possible first and second circles corresponding to the geometric relationship of FIG. 9.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

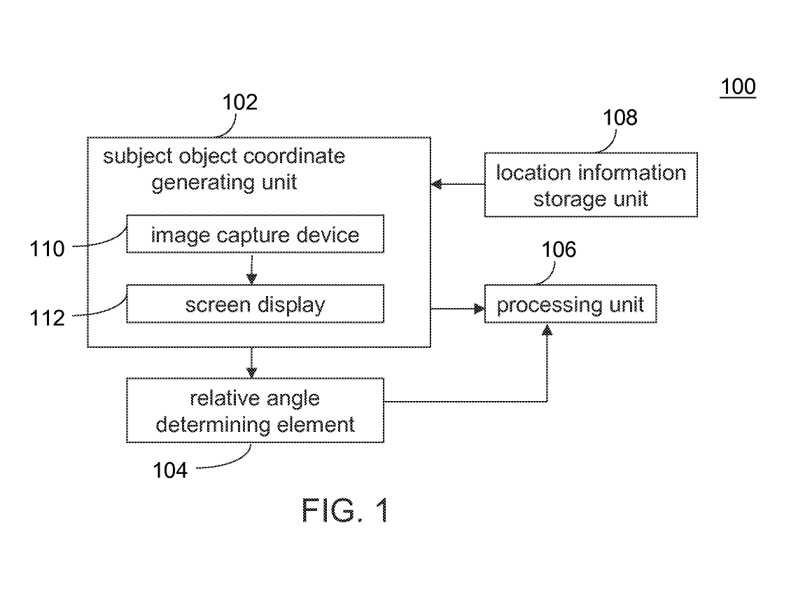

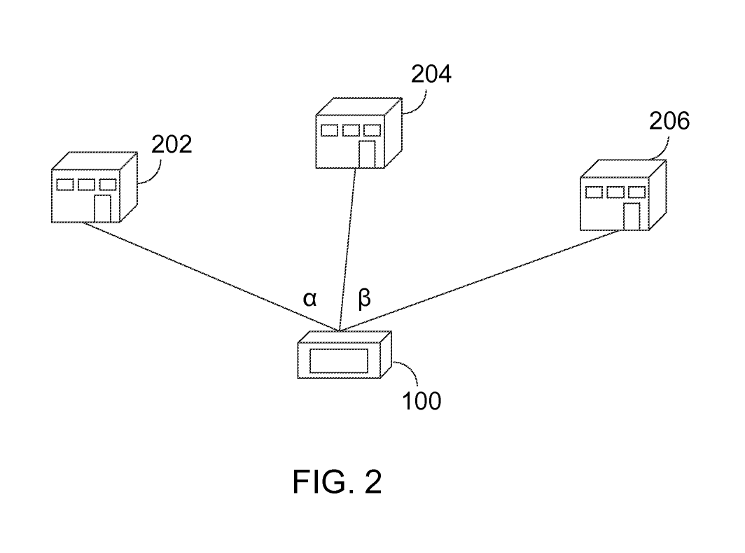

Referring to FIG. 1 and FIG. 2. FIG. 1 shows a block diagram of a localization device 100 assisted with augmented reality of an embodiment of the present disclosure. FIG. 2 shows a schematic diagram of an example of the relationship between the localization device 100 of FIG. 1 and several subject objects. The localization device 100 includes a subject object coordinate generating unit 102, a relative angle determining element 104 and a processing unit 106. The subject object coordinate generating unit 102 selects at least three subject objects outside the localization device 100. The three subject objects are such as subject objects 202, 204 and 206 of FIG. 2. The subject object coordinate generating unit 102 obtains the at least three subject object coordinate values of the at least three subject objects, such as the coordinate (x1, y1) of the subject object 202, the coordinate (x2, y2) of the subject object 204 and the coordinate (x3, y3) of the subject object 206.

The relative angle determining element 104 determines the at least two viewing angle differences between any two of the at least three subject objects, such as the view angle difference α between the subject object 202 and 204 and the viewing angle difference β between the subject object 204 and 206.

The processing unit 106 generates a location coordinate value of the localization device 100 according to the at least two viewing angle differences and the at least three subject object coordinate values. For example, the processing unit 106 generates the location coordinate value (x, y) of the localization device 100 according to the coordinate (x1, y1) of the subject object 202, the coordinate (x2, y2) of the subject object 204, the coordinate (x3, y3) of the subject object 206, and the view angle differences α and β.

Furthermore, the localization device 100 further includes a location information storage unit 108 for storing the at least three subject object coordinate values. The subject object coordinate generating unit 102 obtains the at least three subject object coordinate values of the at least three subject objects from the location information storage unit 108.

However, the localization device 100 can use the subject object coordinate generating unit 102 to obtain the at least three subject object coordinate values of the at least three subject objects from the Internet without using the location information storage unit 108. The at least three subject object coordinate values and the location coordinates value are such as the coordinate values of a global geography coordinate system, or the coordinate values of a user-defined plane coordinate system.

The subject object coordinate generating unit 102 includes an image capture device 110 and a screen display 112. The image capture device 110 respectively captures the images of the above at least three subject objects, and the screen display 112 respectively displays the images of the above at least three subject objects and a user interface. The user interface has an indicative mark. When the screen display 112 displays the images of the above at least three subject objects, the indicative mark selects the above at least three subject objects. The image capture device 110 can be realized by such as a video lens.

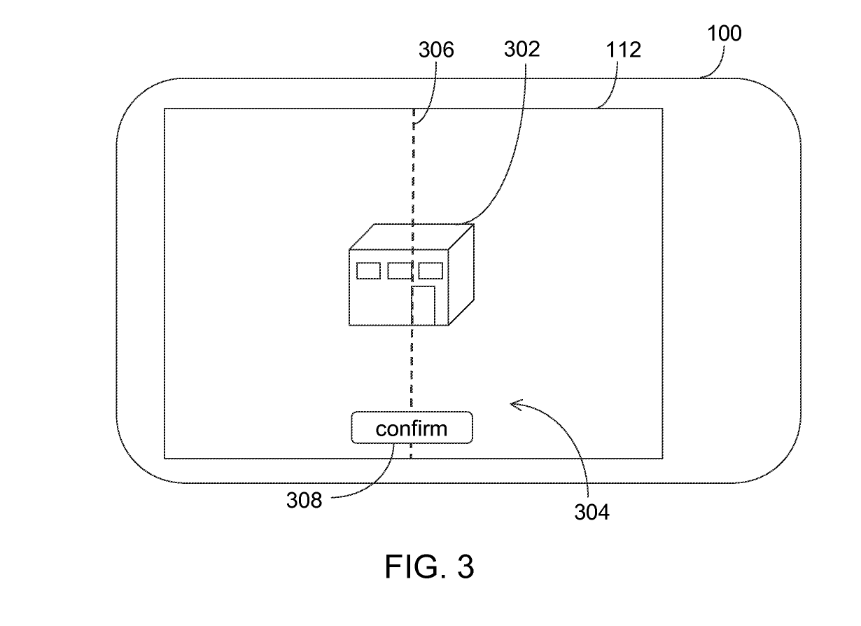

Referring to FIG. 1 and FIG. 3. FIG. 3 shows an example of a user interface displayed on a screen display 112. The screen display 112 displays the image 302 of the subject object 202 and the user interface 304. The user interface 304 has an indicative mark 306. In FIG. 3, the indicative mark 306 is exemplified by a location indicating line located in the middle of the screen display 112, but the present embodiment of the disclosure is not limited to such exemplification. The indicative mark 306 does not have to be located in the middle of the screen display 112 or realized by a straight line, and any mark will do as long as the mark provides the same click criterion for the user to select the subject objects with. When the localization device 100 moves the image 302 of the subject object 202 to be on the indicative mark 306, the user can select the subject object 202 by clicking the confirmation key 308.

The relative angle determining element 104 such as includes an inertial element, which can be realized by such as a magnetometer, a gravity accelerometer or a gyroscope. The magnetometer obtains the contained angle between a subject object and the right north, and the rotation angle of the localization device 100 can be estimated from the angular velocity of the gyroscope. However, the present embodiment is not limited to the above exemplification, and any element capable of measuring angle variation can be used as the relative angle determining element 104 of the present embodiment of the disclosure.

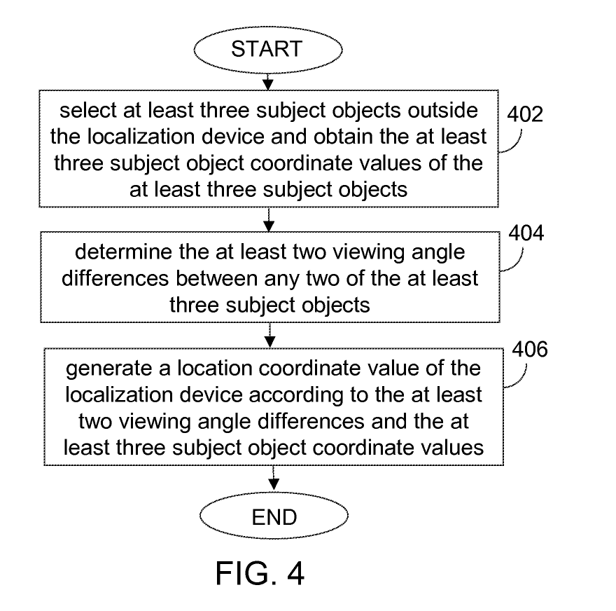

The present embodiment of the disclosure provides a localization method assisted with augmented reality and used in the localization device 100. Referring to FIG. 4, a flowchart of a localization method according to the present embodiment of the disclosure is shown. The method includes steps 402, 404 and 406. In step 402, at least three subject objects outside the localization device 110 are selected and at least three subject object coordinate values of the at least three subject objects are obtained. In step 406, at least two viewing angle differences between any two of the at least three subject objects are determined. In step 406, a location coordinate value of the localization device is generated according to the at least two viewing angle differences and the at least three subject object coordinate values.

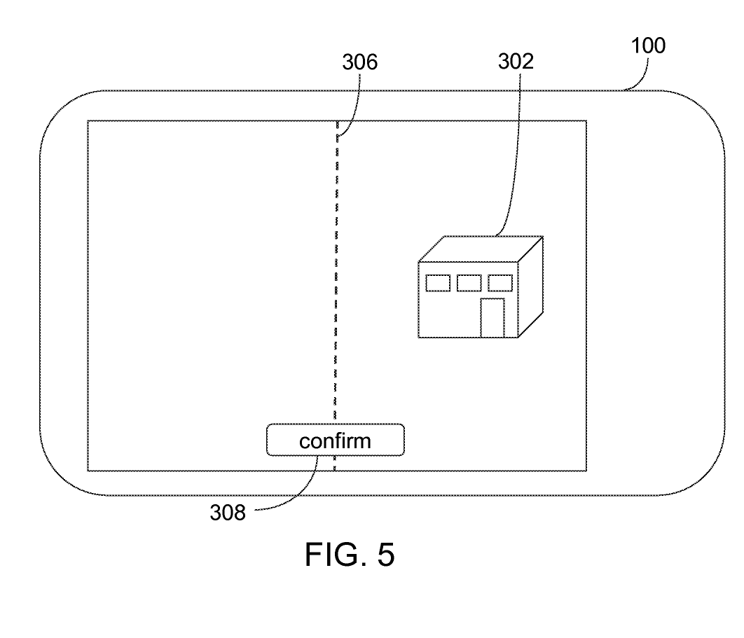

In step 402, when at least three subject objects are respectively selected, the localization device 100 faces the at least three subject objects respectively, and the images of the at least three subject objects displayed by the screen display 112 are respectively located on the indicative mark 306. For example, the localization device 100 faces the subject object 202 of FIG. 2 to capture an image of the subject object 202 and display the captured image on the screen display 112. Meanwhile, the image 302 of the subject object 202 may not be located on the indicative mark 306 as indicated in FIG. 5. Then, the user, standing at the same location, slightly rotates the localization device 100 to face the subject object 202 more precisely and capture the image of the subject object 202 again. If the image of the subject object 202 displayed by the screen display 112 has been moved to be on the indicative mark 306 as indicated in FIG. 3, then, after the user presses the confirmation key 308, the subject object 202 will be selected and the relative angle determining element 104 will generate a viewing angle of the subject object 202.

Then, the user, standing at substantially the same location, again rotates the localization device 100 to face the subject object 204 of FIG. 2 and slightly adjusts the angle of the localization device 100 for enabling the image of the subject object 204 displayed by the screen display 112 to be located on the indicative mark 306. After the user presses the confirmation key 308, the subject object 204 will be selected and the relative angle determining element 104 will generate a viewing angle of the subject object 204. Then, the user, still standing at substantially the same location, rotates the localization device 100 again to face the subject object 206 of FIG. 2 and slightly adjusts the angle of the localization device 100 for enabling the image of the subject object 206 displayed by the screen display 112 to be located on the indicative mark 306. After the user presses the confirmation key 308, the subject object 206 will be selected and the relative angle determining element 104 will generate a viewing angle of the subject object 206. The relative angle determining element 104 will generate view angle differences α and β after the viewing angles of the subject objects 202, 204 and 206 are obtained.

According to another method, after the subject objects 202 and 204 are selected, the relative angle determining element 104 directly detects and uses the rotation angle of the localization device 100 rotated from an angle facing the subject object 202 to an angle facing the subject object 204 as the view angle difference α, and after the subject objects 204 and 206 are selected, the relative angle determining element 104 directly detects and uses the rotation angle of the localization device 100 rotated from an angle facing the subject object 204 to an angle facing the subject object 206 as the viewing angle difference β.

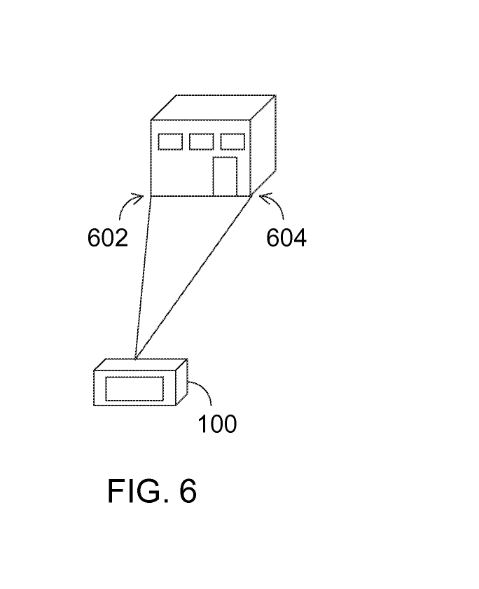

Referring to FIG. 6. Suppose a subject object is too big, and the center point of the subject object is difficult to be aligned with the indicative mark 306 of FIG. 3. Then, the leftmost side 602 and the rightmost side 604 of the subject object are respectively aligned with the indicative mark 306 to obtain respective viewing angles, and the average of the corresponding viewing angles of the leftmost side 602 and the rightmost side 604 is taken and used as a viewing angle of the subject object.

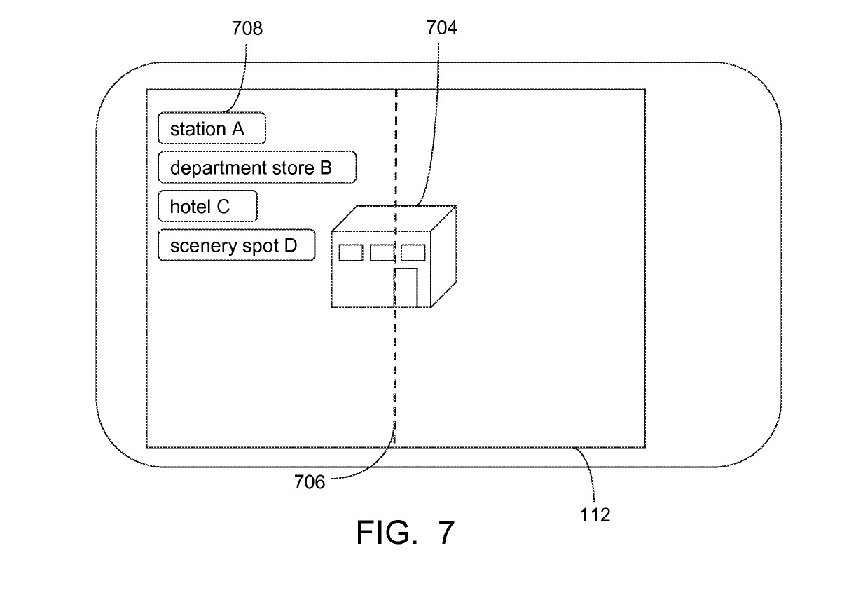

Referring to FIG. 7, a schematic diagram of another example of a user interface is shown. In step 402, the user interface 702 displayed by the screen display 112 further shows the names of several candidate points for the user to select at least three subject objects from the candidate points by way of touch screen or button selection in conjunction with the images of the at least three subject objects (such as the image 704) displayed by the screen display 112 and the indicative mark 706. As indicated in FIG. 7, examples of the candidate points include station A, department store B, hotel C and scenery spot D. The user can select the station A by dragging the station A block 708 to be on the indicative mark 706 by way of touch screen. That is, the image 704 is set as the image of station A, such that the station A is selected as a subject object and the coordinate values of the station A is thus obtained. The user can also select the station A as a subject object by directly clicking the block 708.

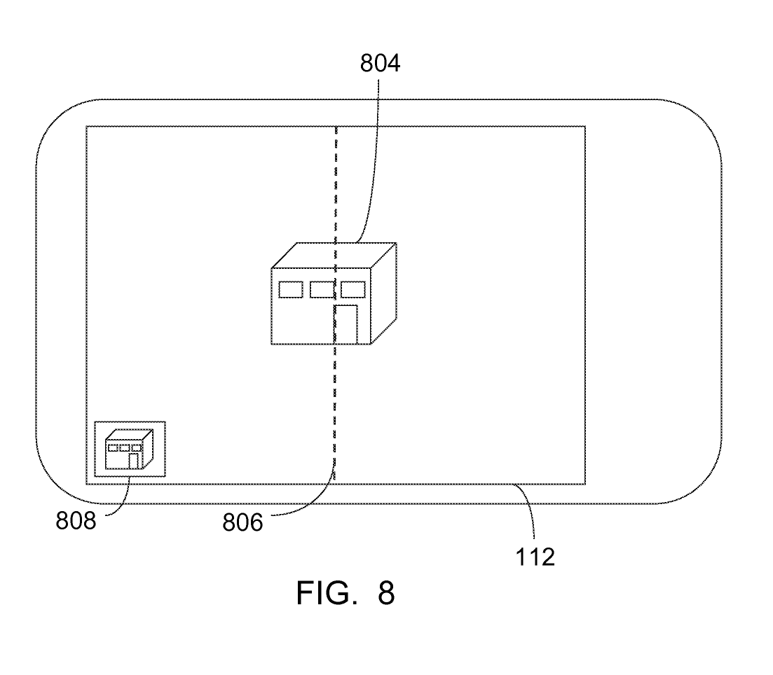

Referring to FIG. 8, a schematic diagram of another example of a user interface is shown. In step 402, the user interface 802 displayed by the screen display 112 further shows the thumbnails of several candidate points (such as the thumbnail 808) for the user to select at least three subject objects from the candidate points by way of touch screen or button selection in conjunction with the images of the at least three subject objects (such as the image 804) displayed by the screen display 112 and the indicative mark 806. If the candidate point denoted by the thumbnail 808 is exactly the target subject object, then the user can drag the thumbnail 808 to the indicative mark 806 by way of touch control to complete the confirmation of selection, or the user can directly click the thumbnail 808 to complete the confirmation of selection.

The above candidate points can be generated according to an initial location of the localization device 100. For example, the landmarks closest to the initial location can be located from several landmarks and used as candidate points. As indicated in FIG. 7, after the initial location of the localization device 100 is obtained, landmarks such as station A, department store B, hotel C and scenery spot D can be located from the several landmarks of the location of the localization device 100 and used as candidate points.

If the localization device 100 has GPS function, then the initial location can be generated according to a received GPS positioning signal, so that the initial location of the localization device 100 can be obtained from the GPS. If the localization device 100 has wireless communication function, then the initial location can be generated from a base station positioning signal received by a wireless communication base station, so that the initial location of the localization device 100 can be obtained from the base station. If the localization device 100 cannot receive the GPS positioning signal for the time being, then the initial location can be determined according to the GPS positioning signal previously received at the vicinity, so that the possible location of the localization device 100 can be preliminarily estimated and used as the above initial location. If the localization device 100 has electronic map function, then the user can locate an initial region of the localization device 100 from an electronic map according to the user's knowledge of the current environment so as to generate the above initial location.

The location information storage unit 108 further stores the above several landmarks and their coordinate values. In step 402, several landmarks closest to the initial location are located from the landmarks stored in the location information storage unit 108 according to the initial location and used as the candidate points. In step 402, the landmarks and their coordinate values can also be obtained from the Internet.

Step 406 of FIG. 4 such as includes the following steps. Based on the geometric relationship that any two subject objects and the localization device 100 lie one the same circle, a first circle center coordinate parameter and a first circle corresponding to each other are generated. Based on the geometric relationship that any other two subject objects and the localization device 100 lie on the same circle, a second circle center coordinate parameter and a second circle corresponding to each other are correspondingly generated. The intersection point of the first circle and the second circle is selected, and the location coordinate value of the localization device 100 is determined according to the at least two viewing angle differences. The process is exemplified below.

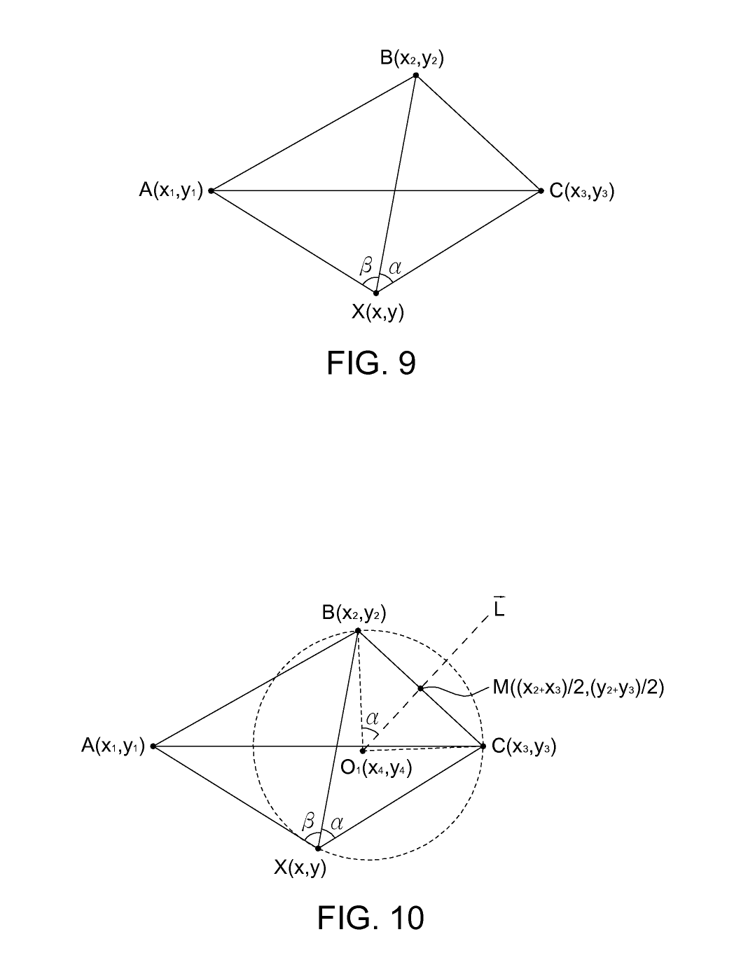

The relationships between the localization device 100 and subject objects 202, 204 and 206 of FIG. 2 are respectively represented by points X, A, B and C of FIG. 9, and the coordinates of the points X, A, B and C respectively denoted by X (x, y), A (x1, y1), B (x2, y2), and C (x3, y3). X (x, y) is to be found. The point X (x, y) satisfies ∠BXC=α, ∠BXA=β.

Referring to FIG. 10. The parameter expression of the center point O1 (x4, y4) of the circle on which the triangle ΔBXC lies is obtained first. Given that the three perpendicular bisectors intersects at the center point of the circle on which the triangle lies, let the center point O1 be on the perpendicular bisector \vec{L} of the straight line B̅C̅, and point M be the middle point of the points B and C, then the parameter expressions of the center point O1 are as follows:

$$x 4 = \frac{{x}_{2} + {x}_{3}}{2} + ( {y}_{2} - {y}_{3} ) t$$

$$y 4 = \frac{{y}_{2} + {y}_{3}}{2} + ( {x}_{3} - {x}_{2} ) t$$

Next, the coordinates of the center point O1 are calculated according to the condition of the view angle difference α. If the view angle difference α<90°, given that O̅₁̅B̅= O̅₁̅M̅cscα, then the following expressions are obtained:

$${[ \frac{{x}_{2} + {x}_{3}}{2} + ( {y}_{2} - {y}_{3} ) t - {x}_{2} ]}^{2} + {[ \frac{{y}_{2} + {y}_{3}}{2} + ( {x}_{3} - {x}_{2} ) t - {y}_{2} ]}^{2} = [ {( \frac{{x}_{3} - {x}_{2}}{2} )}^{2} + {( \frac{{y}_{3} - {y}_{2}}{2} )}^{2} ] {csc}^{2} α$$

$${t}^{2} = \frac{1}{4} ( {csc}^{2} α - 1 ) ⇒ t = \pm \frac{1}{2} cot α$$

Thus, the possible coordinates of the center point O1 are expressed as follows:

$${O}_{1} : ( \frac{{x}_{2} + {x}_{3}}{2} - \frac{1}{2} ( {y}_{2} - {y}_{3} ) cot α , \frac{{y}_{2} + {y}_{3}}{2} - \frac{1}{2} ( {x}_{3} - {x}_{2} ) cot α )$$

$$or$$

$${O}_{1}^{′} : ( \frac{{x}_{2} + {x}_{3}}{2} + \frac{1}{2} ( {y}_{2} - {y}_{3} ) cot α , \frac{{y}_{2} + {y}_{3}}{2} + \frac{1}{2} ( {x}_{3} - {x}_{2} ) cot α )$$

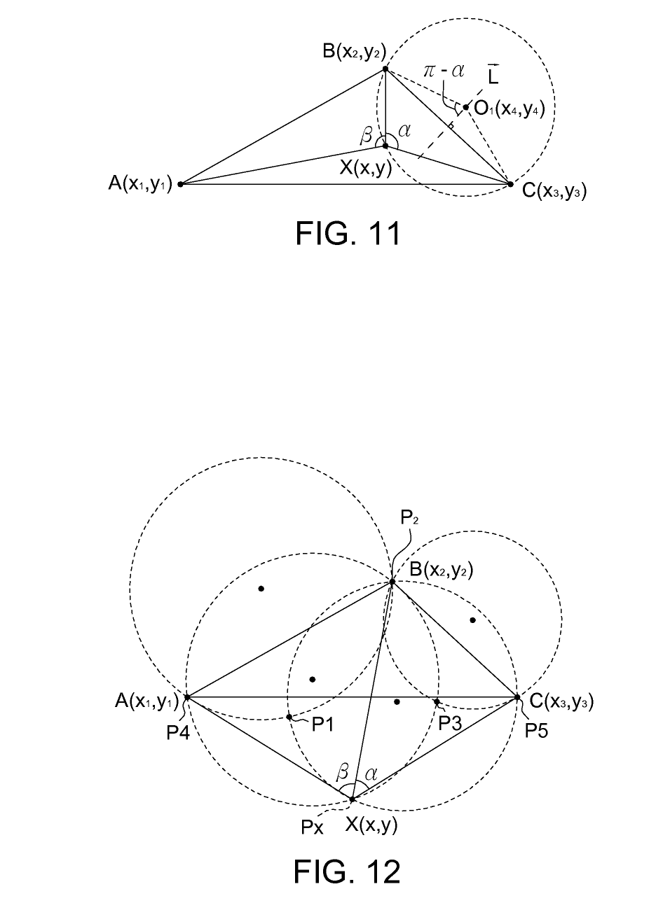

If the view angle difference α>90° as indicated in FIG. 11, given that O̅₁̅B̅= O̅₁̅M̅csc(π−α), then the following expressions are obtained:

$${[ \frac{{x}_{2} + {x}_{3}}{2} + ( {y}_{2} - {y}_{3} ) t - {x}_{2} ]}^{2} + {[ \frac{{y}_{2} + {y}_{3}}{2} + ( {x}_{3} - {x}_{2} ) t - {y}_{2} ]}^{2} = [ {( \frac{{x}_{3} - {x}_{2}}{2} )}^{2} + {( \frac{{y}_{3} - {y}_{2}}{2} )}^{2} ] {csc}^{2} ( π - α )$$

$${t}^{2} = \frac{1}{4} ( {csc}^{2} ( π - α ) - 1 ) ⇒ t = \pm \frac{1}{2} cot ( π - α )$$

Thus, the possible coordinates of the center point O1 are expressed as follows:

$$( \frac{{x}_{2} + {x}_{3}}{2} - \frac{1}{2} ( {y}_{2} - {y}_{3} ) cot ( π - α ) , \frac{{y}_{2} + {y}_{3}}{2} - \frac{1}{2} ( {x}_{3} - {x}_{2} ) cot ( π - α ) )$$

$$or \\ ( \frac{{x}_{2} + {x}_{3}}{2} + \frac{1}{2} ( {y}_{2} - {y}_{3} ) cot ( π - α ) , \frac{{y}_{2} + {y}_{3}}{2} + \frac{1}{2} ( {x}_{3} - {x}_{2} ) cot ( π - α ) )$$

If the view angle difference α=90°, then the coordinates of the center point O1 are expressed as:

$$( \frac{{x}_{2} + {x}_{3}}{2} , \frac{{y}_{2} + {y}_{3}}{2} )$$

Next, the parameter expressions of the coordinates of the center point O2 (x5, y5) on which the triangle ΔBXA lies are calculated according to the above method for obtaining the center point O1, and the coordinates of the center point O2 are calculated according to the condition of the view angle difference β.

Then, as indicated in FIG. 12, all possible circles corresponding to the center points O1 and O2 are illustrated and all possible intersection points {P1, P2, P3 . . . Pn|nεN} on the circles are obtained. Then, all intersection points are checked one by one, and the coordinates of the intersection point Px satisfying the conditions ∠BPC=α and ∠BPA=β are exactly the coordinates of the point X, and are exactly the coordinate values of the location of the localization device 100.

The present embodiment of the disclosure provides a computer program product having a computer program. After the computer program is loaded and executed in the localization device, the localization device performs the localization method assisted with augmented reality as indicated in FIG. 4.

The present embodiment of the disclosure provides a localization device assisted with augmented reality and a localization method thereof of are capable of promptly and effectively positioning the location of the localization device for increasing the correctness and performance of the augmented reality and have the advantage of low cost.

It will be apparent to those skilled in the art that various modifications and variations can be made to the disclosed embodiments. It is intended that the specification and examples be considered as exemplary only, with a true scope of the invention being indicated by the following claims and their equivalents.

What is claimed is:

1. A localization device assisted with augmented reality, comprising:
a subject object coordinate generating unit for selecting at least three subject objects outside the localization device and obtaining the at least three subject object coordinate values of the at least three subject objects;
a relative angle determining element for determining the at least two viewing angle differences between any two of the at least three subject objects; and
a processing unit for generating a location coordinate value of the localization device according to the at least two viewing angle differences and the at least three subject object coordinate values.

2. The localization device according to claim 1, wherein the subject object coordinate generating unit comprises:
an image capture device for respectively capturing the images of the at least three subject objects;
a screen display for respectively displaying the images of the at least three subject objects and a user interface having an indicative mark;
wherein when the screen display displays the images of the at least three subject objects, the indicative mark select the at least three subject objects.

3. The localization device according to claim 1, further comprising:
a location information storage unit for storing the at least three subject object coordinate values, wherein the subject object coordinate generating unit obtains the at least three subject object coordinate values of the at least three subject objects from the location information storage unit.

4. The localization device according to claim 1, wherein the subject object coordinate generating unit obtains the at least three subject object coordinate values of the at least three subject objects from the Internet.

5. The localization device according to claim 1, wherein the relative angle determining element comprises an inertial element.

6. The localization device according to claim 5, wherein the inertial element comprises a magnetometer, a gravity accelerometer or a gyroscope.

7. The localization device according to claim 1, wherein the at least three subject object coordinate values and the location coordinate value are the coordinate values of a global geography coordinate system.

8. The localization device according to claim 1, wherein the at least three subject object coordinate values and the location coordinate value are the coordinate values of a user-defined plane coordinate system.

9. A localization method assisted with augmented reality used in a localization device, the method comprising:
selecting at least three subject objects outside the localization device and obtaining the at least three subject object coordinate values of the at least three subject objects;
determining the at least two viewing angle differences between any two of the at least three subject objects; and
generating a location coordinate value of the localization device according to the at least two viewing angle differences and the at least three subject object coordinate values.

10. The localization method according to claim 9, wherein in the selection step, the images of the at least three subject objects are respectively captured by an image capture device, and the images of the at least three subject objects and a user interface having an indicative mark are displayed by a screen display;
wherein when the screen display displays the images of the at least three subject objects, the indicative mark select the at least three subject objects.

11. The localization method according to claim 10, wherein when the at least three subject objects are respectively selected, the localization device respectively faces the at least three subject objects, and the images of the at least three subject objects displayed by the screen display are respectively positioned on the indicative mark.

12. The localization method according to claim 10, wherein in the selection step, the screen display further displays at least one of the name and the thumbnail of a plurality of candidate points for a user to select the at least three subject objects from the candidate points by way of touch screen or button selection in conjunction with the images of the at least three subject objects and the indicative mark displayed by the screen display.

13. The localization method according to claim 12, wherein in the selection step, the landmarks closest to an initial location of the localization device are located from a plurality of landmarks according to the initial location of the localization device and used as the candidate points.

14. The localization method according to claim 13, wherein the localization device comprises a location information storage unit for storing the landmarks and the coordinate values of the landmarks, and in the selection step, the landmarks closest to the initial location are located from the landmarks stored in the location information storage unit according to the initial location and used as the candidate points.

15. The localization method according to claim 13, wherein in the selection step, the landmarks and the coordinate values of the landmarks are obtained from the Internet.

16. The localization method according to claim 13, wherein in the selection step, the initial location is generated according to a global positioning system (GPS) positioning signal, according to a base station positioning signal, through a previous GPS positioning signal, or according to an initial region set by the localization device.

17. The localization method according to claim 9, wherein in the determining step, the at least two viewing angle differences are determined by an inertial element.

18. The localization method according to claim 17, wherein the inertial element comprises a magnetometer, a gravity accelerometer or a gyroscope.

19. The localization method according to claim 9, wherein the at least three subject object coordinate values and the location coordinate value are the coordinate values of a global geography coordinate system, or the coordinate values of a user-defined plane coordinate system.

20. The localization method according to claim 9, wherein the step of generating the location coordinate value of the localization device comprises:
generating a first circle center coordinate parameter and a first circle based on the geometric relationship that any two subject objects and the localization device lie one the same circle;
generating a second circle center coordinate parameter and a second circle based on the geometric relationship that any other two subject objects and the localization device lie one the same circle; and
selecting the intersection point of the first circle and the second circle and determining the location coordinate value of the localization device according to the at least two viewing angle differences.

21. A computer program product having a computer program, a localization device performing a localization method assisted with augmented reality after the computer program is loaded and executed in the localization device, the localization method comprising:
selecting at least three subject objects of the localization device and obtaining the at least three subject object coordinate values of the at least three subject objects;
determining the at least two viewing angle differences between any two of the at least three subject objects; and
generating a location coordinate value of the localization device according to the at least two viewing angle differences and the at least three subject object coordinate values.

22. The computer program product according to claim 21, wherein in the selection step, the images of the at least three subject objects are respectively captured by an image capture device, and the images of the at least three subject objects and a user interface having an indicative mark are displayed by a screen display;
wherein when the screen display displays the images of the at least three subject objects, the indicative mark select the at least three subject objects.

23. The computer program product according to claim 22, wherein when the at least three subject objects are respectively selected, the localization device respectively faces the at least three subject objects, and the images of the at least three subject objects displayed by the screen display are respectively positioned on the indicative mark.

24. The computer program product according to claim 22, wherein in the selection step, the screen display further displays at least one of the name and the thumbnail of a plurality of candidate points for a user to select the at least three subject objects from the candidate points in conjunction the images of the at least three subject objects and the indicative mark displayed by the screen display.

25. The computer program product according to claim 24, wherein in the selection step, the landmarks closest to an initial location of the localization device are located from a plurality of landmarks according to the initial location of the localization device and used as the candidate points.

26. The computer program product according to claim 25, wherein, the localization device comprises a location information storage unit for storing the landmarks and the coordinate values of the landmarks, and in the selection step, the landmarks closest to the initial location are located from the landmarks, stored in the location information storage unit according to the initial location, and used as the candidate points.

27. The computer program product according to claim 25, wherein in the selection step, the landmarks and the coordinate values of the landmarks are obtained from the Internet.

28. The computer program product according to claim 25, wherein, in the selection step, the initial location is generated according to a global positioning system (GPS) positioning signal, according to a base station positioning signal, through a previous GPS positioning signal, or according to an initial region set by the localization device.

29. The computer program product according to claim 21, wherein in the determining step, the at least two viewing angle differences are determined by an inertial element.

30. The computer program product according to claim 29, wherein the inertial element comprises a magnetometer, a gravity accelerometer or a gyroscope.

31. The computer program product according to claim 21, wherein the at least three subject object coordinate values and the location coordinate value are the coordinate values of a global geography coordinate system, or the coordinate values of a user-defined plane coordinate system.

32. The computer program product according to claim 21, wherein the step of generating the location coordinate value of the localization device comprises:
generating a first circle center coordinate parameter and a first circle based on the geometric relationship that any two subject objects and the localization device lie one the same circle;
generating a second circle center coordinate parameter and a second circle based on the geometric relationship that any other two subject objects and the localization device lie one the same circle; and
selecting the intersection point of the first circle and the second circle and determining the location coordinate value of the localization device according to the at least two viewing angle differences.
